(19) United States
(12) Patent Application Publication
(10) Pub. No.: US 2003/0195643 A1
(43) Pub. Date: Oct. 16, 2003

(54) Method and apparatus for acceleration limiting a position command for motion control

(76) Inventors: Jeffrey G. Knirck, Sunnyvale, CA (US); Paul A. Swanson, Cupertino, CA (US)

Correspondence Address: Jeff Knirck, 868 Jasmine Dr., Sunnyvale, CA, 94086, US

(21) Appl. No.: 10/120,316

(22) Filed: Apr. 11, 2002

(51) Int. Cl. G05B 13/02; G05B 19/18; G05B 11/32; G06F 19/00

(52) U.S. Cl. 700/69; 700/63; 700/55; 700/37; 700/45; 700/188

(57) ABSTRACT

An acceleration limiting electronic filter for a position motion control system is disclosed. The filter is used in conjunction with a position control system to precisely control the position of a device. The present invention limits the acceleration content of a position command signal to some value less than what the control system can execute so that the control system does not clip the acceleration and degrade control.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

The present invention relates to motion control, and more particularly, to pre-filtering the position command to limit the resultant acceleration content.

In motion control of a motor to position a load, linear control laws are typically used. They are well understood, easy to implement and perform well in most cases. Almost all commercially available motion controllers use linear control laws. They may or may not have additional nonlinear terms to limit the amplitudes of position, velocity, acceleration, and or jerk. The amplifier that actually drives the motor in the motion control system inherently has a maximum current that it can provide which sets an acceleration limit. Motion control systems can be a single device, but they are typically composed of a few separate items manufactured by separate companies. Motion control systems typically include a motion controller, an amplifier, a motor, a load, and a load position sensor. The motion controller generates a position command or receives an external position command, and uses the position feedback information from the load position sensor. The motion controller commands the amplifier, which drives the motor, which moves the load. The user, external to the controller, may provide the position command waveform or the controller may provide a means to generate and or store a position command waveform. In either case, the position command waveform is typically not specifically created with an acceleration content that is limited to what the motion control system can actually produce. The result is an actual acceleration that is clipped causing nonlinearity. In this case the nonlinearity results in an accumulation of position error, which can drive the system unstable.

The most common position command is a step function from the present system position to a new desired position. The next most common command waveform is a saw tooth composed of a repeating linear ramp in one direction then a linear ramp in the opposite direction. The velocity content of the saw tooth is limited. The velocity content of the step function is infinite. The acceleration content of both the step function and the saw tooth is infinite.

If the control law has a high gain with a minimum of phase and gain margin any clipping will drive the system unstable, which can cause the system to damage itself. This effect can be eliminated for a range of position command step amplitudes by reducing the gain and increasing the damping. But, at lower command step amplitudes that would not have causes clipping, the system performance is severely reduced. For still larger command step amplitudes the system will still go unstable.

Some controller manufacturers provide a velocity limiting pre-filter. This can help the situation but it still allows an infinite acceleration command. This function helps reduce the accumulation of tracking error. Also, if the limit is low enough, a velocity limit can allow the controller time to recover from an infinite acceleration command before the infinite deceleration command. In any case, a problem exists that has not been properly addressed in the existing art.

Kim U.S. Pat. No. 6,046,564 (April 2000) teaches how to make a “filtered speed profile” which is the output of a low pass filter for the purpose of producing a “filtered speed profile that is smoother than the initial speed profile”. Kim is differentiated from the present invention by both purpose and means. Kim uses a low pass filter to make a smooth speed profile. The present invention uses a nonlinear multi-stage filter to limit the amplitude and frequency content of the second time derivative of a position profile to insure that the control system can properly execute the profile.

Boehm U.S. Pat. No. 5,073,748 (December 1991) teaches how to make a driving system that includes an acceleration rate of change limiter to execute smooth motions. Boehm is differentiated from the present invention by both purpose and means. Boehm uses a discrete time pulse filter linear) convolution method to “avoid sudden variations in the acceleration settings” to produce a smooth profile.

Hara U.S. Pat. No. 5,057,756 (October 1991) teaches how to make a filter to control acceleration for the purpose of “restraining vibration of servomotors”. Hara is differentiated from the present invention by both purpose and means. Hara uses a linear) delay unit filter scheme to remove the discontinuities in acceleration and jerk to produce a smooth profile.

Goor U.S. Pat. No. 4,769,583 (September 1988) teaches how to make a “minimum time path generation routine for a motion control system”. Goor is differentiated from the present invention by both purpose and means. Goor uses a linear predictor and real-time actual position feedback to control a “voltage mode power amplifier” to drive a servomotor of a control system. The present invention uses a nonlinear pre-filter to limit the amplitude and frequency content of the acceleration content of a position profile that is to be fed to a control system to execute.

### BRIEF SUMMARY OF THE INVENTION

The principal object of the present invention is to provide a means to accept an arbitrary position command waveform and produce a position command waveform to the control system that has a fixed peak acceleration content and limited acceleration bandwidth. The acceleration amplitude and bandwidth being limited to some value less than what the control system can execute so that the control system does not clip the acceleration and loose control.

The present invention takes the form of a filter with a transfer function that produces an acceleration limited position command waveform. The filter can be executed in analog electronics or as an algorithm that can be executed by various means including a computer, a microprocessor, or a Digital Signal Processor. The filter parameters are customized to match the control system acceleration limits, torque constant and load inertia.

The present invention would be ideal as an electronic signal filter between the source of a position command and the control system that must execute the command. The present invention is an electronic signal filter apparatus, for use with a motion control system that filters an input position command signal to produce a resultant filtered position command signal with a limited acceleration content. The presence of the filter would allow the position command to be a simple step function. It would also allow the control system to be tuned for maximum performance with a small step and still be able to execute a large step without going unstable, with the same tuning.

Other objects, features and advantages of the present invention will become apparent from the following detailed description when taken in conjunction with the accompanying drawings.

### BRIEF DESCRIPTION OF THE SEVERAL VIEWS OF THE DRAWINGS

FIG. 1 is a block diagram of a generalized embodiment of the invention using a closed-loop architecture and nonlinear velocity damping.

FIG. 2 is a block diagram of a generalized embodiment of the invention using a closed-loop architecture and nonlinear forward gain.

FIG. 3 is a phase diagram showing the path of a move from an initial point to a final point that would be produced by the present invention.

FIGS. 4A, 4B, 4C and 4D are diagrams showing typical acceleration versus time profiles.

FIG. 5 is a listing of an algorithm for executing a relative position move with a limited acceleration content.

### DETAILED DESCRIPTION OF THE INVENTION

The present invention provides a filter for use in motion control systems. The advantage is that the present invention will filter a position command waveform to limit the acceleration content of the position command waveform to an acceleration that the control system can execute without the risk of going unstable due to the nonlinear effects of clipping.

The present invention can be implemented in various embodiments. In any case the basic concept is the same. The filter transfer function can be implemented in hardware or in software. There are advantages and disadvantages either way. The filter transfer function can be implemented as a function with or without one or more internal feedback loops. There are advantages and disadvantages either way.

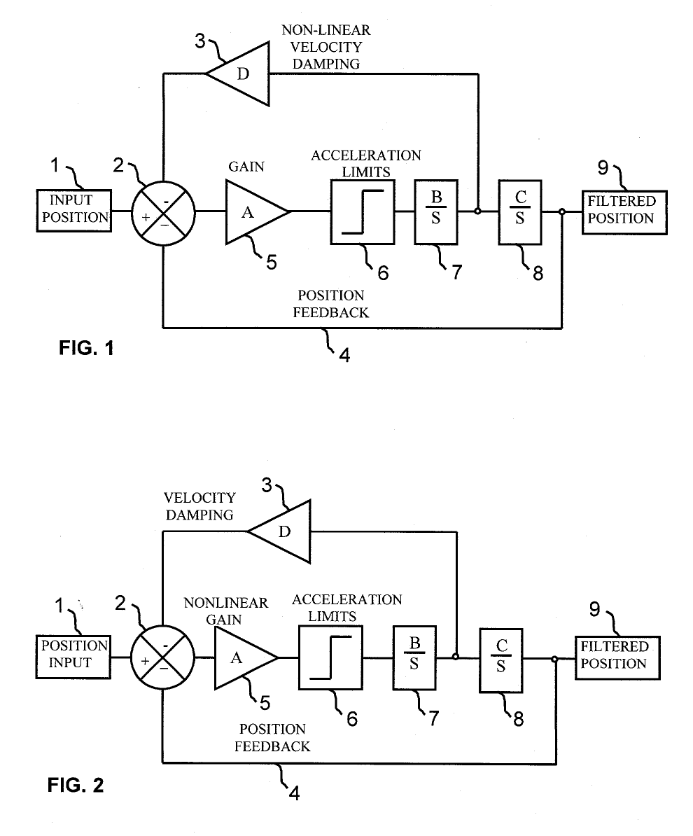

A, B, C, D in FIG. 1 and FIG. 2 represent gain constants of their function and S represents the Laplace frequency variable, such that “B/S” acts as an integrator with gain B. FIG. 1 depicts a block diagram of a generalized embodiment of the invention using a closed-loop architecture. The figure shows that an Input Position waveform 1 enters a summing junction 2 where it is combined with negative feedback of Nonlinear Velocity Damping 3 and Position Feedback 4 to form an error signal. The resultant error signal passes through a Gain stage 5 then through a signal clipping function 6 that limits the acceleration amplitude of the resultant signal. The gain stage 5 could be a constant gain if appropriate nonlinear damping is used. Conversely, a simpler damping function 3 could be used if the Gain stage 5 is tuned to provide the desired compensation. The slew rate of the output of the Gain stage 5 is proportional to the jerk content of the resultant filtered position. The Gain stage 5 function can be tuned to limit the jerk content to some desired value. The output of a first integrator stage 7 has units of velocity. The output of a second integrator stage 8 has units of position. This resultant Filtered Position signal 9 is a position command waveform with an acceleration content that is specifically limited to a set value. The set acceleration limit value is chosen to be slightly less than what the control system can actually execute so that the control system does not inadvertently clip the waveform and cause nonlinearity that leads to instability. The combined gains, B and C, of the two integrator stages 7 and 8 are set to be equivalent to the acceleration constant of the motor and load of the subject motion control system. The loop must produce a resultant filtered position command signal with an acceleration bandwidth that is limited to no more than the bandwidth of the control system that will execute the resultant position command waveform. A generalized cubic function (ax³+bx²+cx+d) or gain scheduling are good implementations of the Nonlinear Velocity Damping. Both are relatively easy to implement in both hardware and software and seems to provide adequate damping of the nonlinear action of the Acceleration Limits 6.

FIG. 2 depicts a block diagram of an embodiment of the invention using a nonlinear gain function in a closed-loop architecture. Like FIG. 1, FIG. 2 figure shows that an Input Position waveform 1 enters a summing junction 2 where it is combined with negative feedback of Velocity Damping 3 and Position Feedback 4 to form an error signal. In this case, the gain block 5 is shown as Nonlinear. The function of blocks 5 and 6 can easily be combined into a single function. Again, the gains of the filter shown in FIG. 2 must be set to complement the gains of the control system that uses the resultant Filtered Position command signal 9, and the loop must have an acceleration bandwidth that is limited to no more than the bandwidth of the control system that will execute the resultant position command waveform.

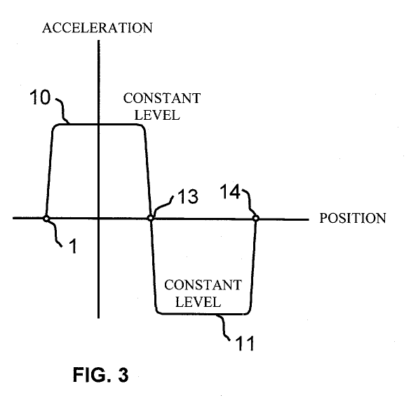

FIG. 3 depicts a phase diagram showing the path of a commanded position move that would be produced by the present invention. The vertical axis is acceleration. The horizontal axis is position. The move starts at point 12. A Constant acceleration is applied with amplitude 10 for some time until point 13 is reached. At point 13 the acceleration is reversed and a constant acceleration of amplitude 11 is applied until the destination point 14 is reached. The waveform is shown to be bandwidth limited. The switch point 13 is calculated so that the final velocity at point 14 is zero. In the case of the embodiments suggested by FIG. 1 and FIG. 2, acceleration limit levels 10, 11 are executed in Acceleration Limits function block 6, and the switch point 13 is a natural product of a properly tuned closed-loop filter using the damping and stabilizing functions 3, 4, and 5 shown in FIG. 1 and FIG. 2.

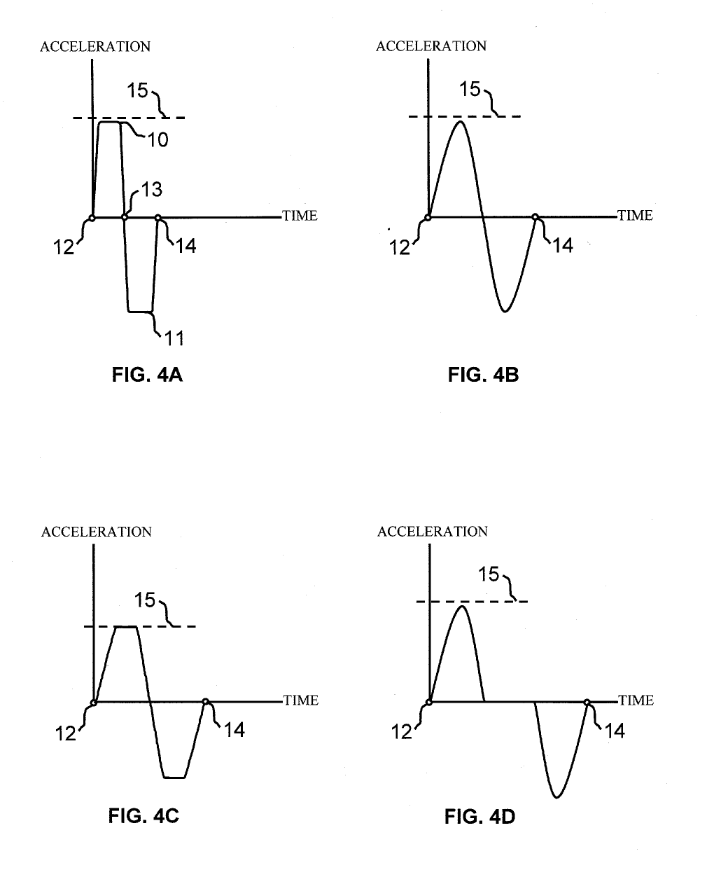

FIGS. 4A, 4B, 4C and 4D are diagrams showing typical acceleration versus time profiles for control systems trying to execute a position step function from an initial point 12 to a final point 14. FIGS. 4B, 4C and 4D show the limitations of the Prior Art. In each figure, the acceleration level 15 represents the physical limit of acceleration of the control system. Typically the acceleration limit exists because the amplifier that drives the motor is only capable of producing a certain maximum current. Both a positive and negative acceleration limit exists, and they may be different. Like FIG. 3, FIG. 4A shows the execution of a position move that would be produced by the present invention. For a given peak acceleration, 10 and 11, FIG. 4A shows that the time to execute the step would be faster compared to FIGS. 4B, 4C and 4D. FIG. 4B shows the execution of a position move that would typically be produced by a control system that is properly tuned for a give step amplitude. FIG. 4C shows the execution of a position move that would typically be produced by a control system that is too aggressively tuned for a given step amplitude such that the commanded acceleration is clipped by physical limits in the amplifier 15. If the clipping is significant, the clipping can cause instability. To fight the induced instability, excessive damping is required which reduces performance. FIG. 4D shows the execution of a position move that would typically be produced by a control system that uses a slew limit technique to try to reduce the tendency to clip when trying to execute large steps. For smaller steps FIG. 4D would look like FIG. 4B. For the larger steps FIG. 4D includes the constant velocity section between acceleration and deceleration curves that compromises performance for larger steps for the advantage of better performance with smaller steps.

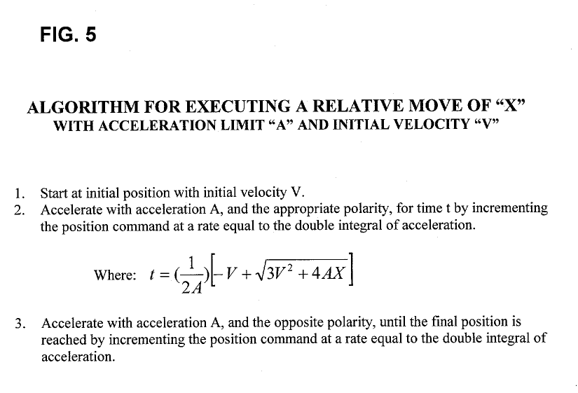

FIG. 5 depicts a listing of an algorithm for executing a relative position move with a fixed acceleration content. In this case the final velocity after the move is assumed to be zero. The math can be derived to accommodate non-zero initial and final velocities, and non-zero initial and final accelerations. The algorithm described in FIG. 5 would most likely be implemented in software. The algorithm in FIG. 5 is intended to accept an initial position and velocity and produce incrementally updated position commands until the final desired position destination is commanded. Similar to what is depicted in FIG. 3, the algorithm in FIG. 5 starts at an initial position and prescribes a constant acceleration “A” for a time “t” while issuing incremental position commands. At time “t” as described in FIG. 5 the position would be the same as at point 13 in FIG. 3. FIG. 5 contains the mathematical expression for calculating “t” based on the desired relative move distance “X”, the desired limited acceleration “A” and the initial velocity “V”. At time “t” the acceleration is reversed and incremental position commands are issued until the final position is reached. This final position is the same as described by point 14 in FIG. 3. The resultant position command waveform must have an acceleration bandwidth that is limited to no more than the bandwidth of the control system that will execute the resultant position command waveform.

The above descriptions are illustrative and not restrictive. Many variations of the invention will become apparent to those skilled in the art upon review of this disclosure. Merely by way of example, the damping term in the filter can be created in various ways. The velocity signal can be fed back directly or the derivative of the final position could be use. The nonlinear damping term or the nonlinear gain term could be implemented as higher order continuous functions of their inputs or they could be implemented to be piecewise continuous by using gain scheduling. The acceleration limits could be asymmetric if that is required by the control system that uses the output of the filter. In any of the embodiments further restrictions could be added to limit the maximum velocities or jerk. Any of the gains or values of the filter could be made fixed or adjustable as needed by a specific application. The invention can be built as a separate module to be used as a pre-filter for a commercial servo controller or its function can be incorporated into a commercial controller. Different operating sequences can also be used to tailor the operation of the invention to a particular application. The scope of the invention should therefore be determined not just with reference to the above description, but instead should be determined with reference to the appended claims along with their full scope of equivalents.

The present invention takes the form of a filter with a transfer function that produces an acceleration limited position command waveform. The present invention is used as a series element between the source of a position command and the control system that must execute the command. The input position command signal passes through the filter that produces a resultant filtered position command signal with a limited acceleration amplitude and bandwidth content. The resultant filtered position command signal is used by a position motion control system to execute a move.

We claim:

1. An electronic signal filter apparatus, for use with a motion control system, that filters an input position command signal to produce a resultant filtered position command signal with a limited acceleration content comprising:
a feedback signal;
an error signal which is a combination of the input position command signal and the feedback signal;
a means to limit the amplitude of the error signal which limits the acceleration amplitude of the resultant filtered position command signal;
a gain stage to amplify the error signal; and
two integrators to convert the amplified error signal to the resultant filtered position command signal.

2. The electronic signal filter apparatus of claim 1 wherein the gain stage is nonlinear.

3. The electronic signal filter apparatus of claim 1 wherein the acceleration content of the resultant filtered position command signal is bandwidth limited.

4. The electronic signal filter apparatus of claim 1 wherein the feedback signal includes damping.

5. The electronic signal filter apparatus of claim 1 wherein the combined gains of the two integrators are set to be equivalent to the acceleration constant of the motion control system.

6. An electronic signal filtering method, for use with a motion control system, that filters an input position command signal to produce a resultant filtered position command signal, comprising the steps of:
limiting the acceleration amplitude to what the motion control system can execute; and
limiting the acceleration bandwidth to what the motion control system can execute.

7. An electronic signal filtering method, for use with a motion controller, that filters an input position command signal to produce a resultant filtered position command signal with a limited acceleration content comprising the steps of:
combining the input position command signal and a feedback signal to form an error signal;
limiting the amplitude of the error signal which limits the acceleration amplitude of the resultant filtered position command signal; and
double integrating the limited error signal to produce the resultant filtered position command signal.

8. The electronic signal altering method of claim 7 wherein the feedback signal gain is nonlinear.

9. The electronic signal filtering method of claim 7 wherein the feedback signal includes damping.

10. The electronic signal filtering method of claim 7 wherein the acceleration content of the resultant filtered position command signal also has limited acceleration bandwidth.

11. An electronic signal filtering method, for use with a motion controller, that filters an input position command signal to produce a resultant filtered position command signal with a limited acceleration content comprising the steps of:
determine a position error based on a difference between the input position command signal and the resultant filtered position command signal;
calculate a switch point based on the limited acceleration and the position error;
accelerate with a limited acceleration for a time t by incrementing the resultant filtered position command at a rate equal to the double integral of acceleration; and
at the switch point, accelerate with the limited acceleration of the opposite polarity by incrementing the resultant filtered position command at a rate equal to the double integral of acceleration until the position error is zero.

12. The electronic signal filtering method of claim 11 wherein the acceleration content also has limited acceleration bandwidth.
